(19) United States
(12) Patent Application Publication
(10) Pub. No.: US 2025/0053582 A1
(43) Pub. Date: Feb. 13, 2025

(54) METHOD OF INFORMATION PROCESSING, ELECTRONIC DEVICE AND STORAGE MEDIUM

(71) Applicant: Beijing Zitiao Network Technology Co., Ltd., Beijing (CN)

(72) Inventors: Leiqi YAO, Beijing (CN); Shixing JIN, Beijing (CN); Ying ZHANG, Beijing (CN); Mingxin HUANG, Beijing (CN); Fan XU, Beijing (CN); Chen RAN, Beijing (CN); Zhiwei ZHANG, Beijing (CN); Zhengxing LI, Beijing (CN)

(21) Appl. No.: 18/783,190

(22) Filed: Jul. 24, 2024

(30) Foreign Application Priority Data
Aug. 8, 2023 (CN) 202310996251.9

(51) Int. Cl. G06F 16/332; G06F 9/445; G06F 16/33; G06F 40/35

(52) U.S. Cl. CPC G06F 16/3329; G06F 9/44526; G06F 16/3344; G06F 40/35

(57) ABSTRACT

A method of information processing, an electronic device and a storage medium are provided. The method includes: receiving input information to be processed; acquiring a target answer result of the information to be processed, wherein the target answer result is generated based on a generative model and a target plugin, a cooperative mode in which the generative model and the target plugin generate the target answer result is related to an implementation requirement of a capability of the target plugin, and the target plugin is a plugin that matches with the information to be processed and is used to answer the information to be processed; and displaying the target answer result.

### CROSS-REFERENCE TO RELATED APPLICATION

The present application claims priority of the Chinese Patent Application No. 202310996251.9, filed on Aug. 8, 2023, the disclosure of which is incorporated herein by reference in its entirety as part of the present application.

### TECHNICAL FIELD

The present disclosure relates to a method of information processing, an electronic device and a storage medium.

### BACKGROUND

With the development of computer technology and artificial intelligence, users may search, draw images, etc., based on the artificial intelligence. However, the current artificial intelligence is usually only able to target a single type of questions. How to acquire more accurate results for different types of question requirements is an urgent problem that needs to be solved.

### SUMMARY

The embodiments of the present disclosure provide a method of information processing, which includes:
receiving input information to be processed;
acquiring a target answer result of the information to be processed, in which the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed; and
displaying the target answer result.

The embodiments of the present disclosure further provide an apparatus of information processing, which includes an input module, an acquisition module and a display module.

The input module is configured to receive input information to be processed.

The acquisition module is configured to acquire a target answer result of the information to be processed, in which the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed.

The display module is configured to display the target answer result.

The embodiments of the present disclosure further provide an electronic device, which includes at least one processor and a memory. The memory stores machine-readable instructions that are executed by the processor, the processor is used to execute the machine-readable instructions stored in the memory, and when the machine-readable instructions are executed by the processor, the processor executes any possible implementation of the above-mentioned method of information processing.

The embodiments of the present disclosure further provide a non-transient computer-readable storage medium, in which computer programs are stored in the non-transient computer-readable storage medium, and when the computer programs are executed by a processor, any possible implementation of the above-mentioned method of information processing is implemented.

For the description of the effect of the apparatus of information processing, the computer device, and the non-transient computer-readable storage medium mentioned above, please refer to the description of the above-mentioned method of information processing, which will not be repeated here.

It should be understood that the above general description and the detailed description following are only illustrative and explanatory and do not limit the technical solutions of the present disclosure.

In order to make the above-mentioned purpose, features and advantages of the present disclosure more obvious and easier to understand, preferred embodiments are provided below and illustrated in detail with the attached drawings.

### BRIEF DESCRIPTION OF DRAWINGS

In order to illustrate the technical solutions of the embodiments of the present disclosure more clearly, the drawings required to be used in the embodiments are briefly introduced below. The drawings are incorporated into the specification and form a part of the specification. The drawings show the embodiments that conform to the present disclosure, and are used together with the specification to illustrate the technical solutions of the present disclosure. It should be understood that the following drawings only show some embodiments of the present disclosure, and therefore should not be regarded as a limitation of the scope. Other related drawings can also be derived from these drawings by those ordinarily skilled in the art without creative efforts.

FIG. 1 shows a flow diagram of a method of information processing provided by an embodiment of the present disclosure;

FIG. 2 shows a flow diagram of another method of information processing provided by an embodiment of the present disclosure;

FIG. 3 shows a flow diagram corresponding to a search plugin in a method of information processing provided by an embodiment of the present disclosure;

FIG. 4 shows a flow diagram of another method of information processing provided by an embodiment of the present disclosure;

FIG. 5 shows a schematic diagram of an apparatus of information processing provided by an embodiment of the present disclosure; and

FIG. 6 shows a schematic diagram of an electronic device provided by an embodiment of the present disclosure.

### DETAILED DESCRIPTION

It is understandable that before using the technical solutions disclosed in the embodiments of the present disclosure, the type, scope of use, and use scenarios of the personal information involved in the present disclosure shall be informed to the user and the authorization shall be obtained from the user through appropriate methods in accordance with relevant laws and regulations.

In order to make the purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, instead of all the embodiments. The components of the embodiments of the present disclosure that are typically described and shown here, may be deployed and designed in a variety of different configurations. Therefore, the following detailed description of the embodiments of the present disclosure is not intended to limit the scope of the present disclosure claimed, but merely represents the selected embodiments of the present disclosure. Based on the embodiments of the present disclosure, all other embodiments obtained by those ordinarily skilled in the art without creative efforts belong to the scope of protection of the present disclosure.

It is found from researches that with the development of computer technology and artificial intelligence, functions such as content creation and image drawing may be implemented based on the artificial intelligence. However, question needs of users are usually multifaceted, and the artificial intelligence may only answer a single type of questions, and does not have an ability to answer a certain type of questions, and thus the artificial intelligence cannot provide answer results.

Based on the above researches, the present disclosure provides a method of information processing. The method includes: receiving input information to be processed, and then based on a generative model and by calling a target plugin that can answer the information to be processed, generating a target answer result of the information to be processed according to a cooperative mode of the generative model and the target plugin, thereby displaying the target answer result. Thus, for the input information to be processed, the generative model can call the target plugin that is correspondingly matched and capable of answering, thereby cooperatively processing to generate the final target answer result, which can effectively and accurately answer different types of questions, and improve the problem solving ability and applicability.

The defects of the above scheme are all results obtained by the inventors after practice and careful research. Therefore, the finding process of the above problems and solution schemes proposed in the present disclosure for the above problems in the following text should be contributions made by the inventor to the present disclosure during the present disclosure process.

It should be noted that similar labels and letters represent similar terms in the following drawings. Therefore, once a certain term is defined in one drawing, it does not need to be further defined and explained in the subsequent drawings.

For the convenience of understanding this embodiment, firstly a method of information processing disclosed in the embodiments of the present disclosure is introduced in detail. The executive body of the method of information processing provided by the embodiments of the present disclosure is generally an electronic device with certain computing power, and the electronic device, for example, includes a terminal device, a server, or other processing devices. The terminal device may be user equipment (UE), a mobile device, a cell phone, a cordless phone, a personal digital assistant (PDA), a handheld device, a computing device, a vehicle-mounted device, a wearable device, etc. The PDA is a handheld electronic device that has certain functions of an electronic computer, and may be used to manage personal information, or may browse the internet, send and receive electronic mails, etc. Generally, the PDA is not equipped with a keyboard and may also be called a handheld computer. In some possible implementations, the method of information processing may be implemented by a processor calling computer-readable instructions stored in a memory.

The executive body as the terminal device is taken as an example below, to describe the method of information processing provided by the embodiment of the present disclosure.

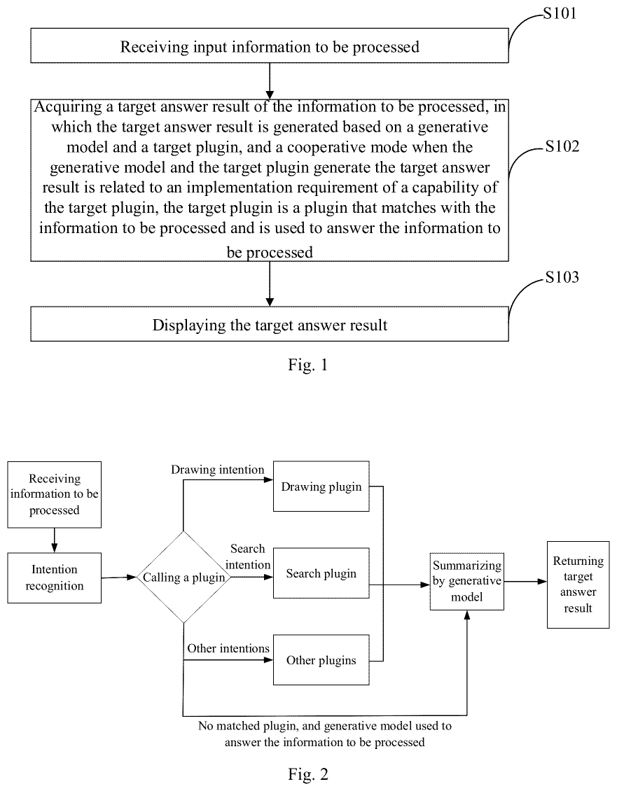

As shown in FIG. 1, which is a flow diagram of a method of information processing provided by an embodiment of the present disclosure, the method includes S101-S103.

S101: receiving input information to be processed.

In the embodiments of the present disclosure, based on the artificial intelligence, a user may be provided with an artificial intelligence (AI) tool. By using the AI tool, the user may input any information to be processed that needs to be queried on a page of the AI tool.

S102: acquiring a target answer result of the information to be processed, in which the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed.

In the embodiments of the present disclosure, the generative model may be understood as a basic large language model, which may also solve many questions in many vertical scenes. However, the ability of the single generative model may be limited, for example, some questions for real-time search requirements, such as what's the weather like today, require real-time search to solve. Therefore, in the embodiments of the present disclosure, based on the generative model, the target plugin that is correspondingly matched and capable of answering may be called, and thus the generative model and the target plugin are mutually cooperated and cooperatively processed to generate the final target answer result, which may meet different question requirements and improve the answer accuracy.

Further, in the embodiments of the present disclosure, a possible implementation is further provided. In response to the information to be processed not matching with the target plugin and the generative model answering the information to be processed, semantic analysis is performed on the information to be processed based on the generative model to generate the target answer result of the information to be processed.

Namely in the embodiments of the present disclosure, when there is no target plugin matched and the information to be processed can be answered based on the generative model itself, then the corresponding target answer result can be directly acquired based on the generative model.

S103: displaying the target answer result.

In the embodiments of the present disclosure, the input information to be processed is received, and the generative model and the target plugin mutually cooperate to generate the target answer result according to the cooperative mode of the generative model and the target plugin, thereby displaying the target answer result. Thus, for any information to be processed input by a user, the correspondingly matched target plugin be recognized accurately and called, and according to the cooperative mode related to the implementation requirement of a capability of the target plugin and based on the mutual cooperation of the generative model and the target plugin, the target answer result may be generated to answer the question requirements in different vertical scenes. Moreover, for different target plugins, the different cooperative modes may be used, or the same cooperative mode that meets the implementation requirement of a capability of the target plugin may be used, thereby the cooperation effect of the generative model and the target plugin can be improved, and the accuracy of the target answer result can be further improved.

In the embodiments of the present disclosure, when the corresponding target plugin is called based on the generative model, the target plugin matched needs to be recognized accurately, and then the target answer result is generated based on the generative model and the target plugin. Specifically, for the method of generating the target answer result, the present disclosure further provides some possible implementations.

In a possible implementation, the target answer result is determined by the following process.

S1: performing intention recognition on the information to be processed to determine a target intention category of the information to be processed, in which the target intention category represents an ability requirement to answer the information to be processed.

In the embodiments of the present disclosure, the intention recognition may be implemented based on the generative model. The present disclosure provides a specific embodiment, which includes: using the information to be processed and an intention judgment prompt statement as input based on the generative model, performing semantic analysis on words included in the information to be processed according to the intention judgment prompt statement, and determining the target intention category matched with the information to be processed. The intention judgment prompt statement is used to indicate an ability requirement judgment requirement of the intention categories and represent a word example corresponding to the intention category.

The intention judgment prompt statement in the embodiments of the present disclosure may be understood as a learning and operating instruction that indicates the generative model. A plurality of requirements may be proposed for the generative model, and some reference examples may also be input, and the imitation and learning ability of the generative model are used to enable the generative model to judge what type of the information to be processed belongs to which intention category.

For example, in the intention judgment prompt statement, different plugins may be used to answer questions. When there is a requirement for timeliness in answering the questions, the intention category is recognized as a search intention and a search plugin is used, for example, some word examples of the search intention may include today's weather, news, stocks, today's hot topics, etc. When there is image description information in the input question, the intention category is recognized as a drawing intention and a drawing plugin is used, for example, some word examples of the drawing intention may include drawing one, drawing one piece, etc. In addition, when the input question may be answered without the need for the plugin, the answer result may be directly generated, for example, the word examples may include writing an essay, etc.

In addition, the intention judgment prompt statement may also include some other requirements, for example, the context of the input information to be processed may also be combined when the answer result is generated, and for another example, the language type requirement, etc., may also be provided, which is not limited in the specific embodiments of the present disclosure.

S2: determining the target plugin that matches with the target intention category according to the target intention category and association relationships between intention categories and plugins, in which abilities implemented by different plugins are different.

For example, a drawing intention is associated with a drawing plugin, the drawing plugin may be a text to picture model, and the drawing vertical scenes may further be subdivided, such as photography drawing and cartoon drawing, thus the drawing plugins in the detailed vertical scenes may be matched, and the accuracy of drawing results can be improved.

For another example, a search intention is associated with a search plugin, and the search plugin, for example, is a certain search engine, the real-time search may be performed by calling the corresponding search engine.

S3: according to the cooperative mode of the generative model and the target plugin, generating the target answer result based on the generative model and the target plugin.

Thus, in the embodiments of the present disclosure, for example, in the main dialogue process or other AI tools for comprehensive vertical scenes, after the user inputs the information to be processed, the intention recognition may be performed on the information to be processed, and the target plugin matched may be determined by the intention recognition, and thus the target answer result is generated by combining the target plugin and the generative model. By the intention recognition, which target plugin to be called can be accurately determined, the efficiency and accuracy are improved, and the information to be processed may be effectively answered.

In another possible implementation, the target answer result is determined by the following process.

S1: when the information to be processed is input for a target functional module that is selected, determining the target plugin associated with the target functional module, in which different target functional modules are used to answer questions in different vertical scenes.

In the embodiments of the present disclosure, based on the artificial intelligence technology, the different vertical scenes may also be subdivided and the AI tools in the different vertical scenes may be implemented to provide the user, for example, a drawing AI tool, a content creation AI tool, and a today's stock market AI tool, etc. Here, the different target functional modules may be understood that one target functional module corresponds to one AI tool. For the specific AI tools, the matched target plugin may be preset, for example, a today's weather AI tool, a today's stock market AI tool, etc., all have real-time timeliness requirements, so the target plugin used may be directly specified as the search plugin.

Then, after the user selects a certain AI tool in a specific vertical scene, the information to be processed is input on a chat page of the AI tool. At this time, there is no need to determine the target plugin by the intention recognition, and the plugin preset for the AI tool can be used as the target plugin and be directly called.

S2: according to the cooperative mode of the generative model and the target plugin, generating the target answer result based on the generative model and the target plugin.

Thus, in the embodiments of the present disclosure, the AI tools in the different vertical scenes may be provided to a user. When the user selects a specific vertical scene and inputs the information to be processed, the target plugin may be directly determined based on a preset association relationship, which is easy to implement and has relatively high efficiency. Thus, based on the cooperative mode that the target plugin is adapted to, the target plugin cooperates with the generative model to generate the target answer result.

For the above two embodiments, the generative model and the target plugin may interact and cooperate with each other according to the cooperative mode related to the implementation requirement of a capability of the target plugin, so as to generate the target answer result more accurately and effectively. Some possible cooperative modes are also provided by the embodiments of the present disclosure. Specifically, the according to the cooperative mode of the generative model and the target plugin, generating the target answer result based on the generative model and the target plugin, may include the following possible embodiments.

1) In a possible embodiment, the target plugin is called by the generative model to acquire an initial answer result of the target plugin, and based on the generative model and the initial answer result, the target answer result of the information to be processed is acquired.

In this embodiment, the cooperative mode of the generative model and the target plugin may be used by placing the target plugin before the generative model, such as some search plugins or some plugins with timeliness requirements, which is not limited in the embodiments of the present disclosure. Real-time search results may be acquired firstly by searching based on the search plugin, and then the real-time search results are summarized based on the generative model to obtain the final target answer result.

2) In another possible embodiment, the target plugin is called by the generative model to acquire the target answer result of the information to be processed generated by the target plugin.

In this embodiment, the cooperative mode of the generative model and the target plugin may be used by placing the target plugin after the generative model, such as a drawing plugin. The generative model may call the drawing plugin and generate an image drawing result based on the drawing plugin.

Certainly, in the embodiments of the present disclosure, there are no restrictions on the cooperative mode of the generative model and the target plugin, and the cooperative mode is not limited to the above two cooperative modes, the cooperative mode can be set based on the implementation requirement of capabilities of the different target plugins, and the target plugin and the generative model may not only interact with each other once, but may also interact and cooperate with each other for many times. For example, the cooperative mode is that the information to be processed is processed based on the target plugin, then is given to the generative model for processing, and then the target answer result is generated finally based on the target plugin.

Further, in the embodiments of the present disclosure, the more specific cooperative processing process is further provided by using the search plugin and the drawing plugin as an example, which are respectively described below.

In a possible situation, when the target plugin is the search plugin, the cooperative mode of the search plugin and the generative model is that the target plugin is called by the generative model to acquire an initial answer result of the target plugin, and the target answer result of the information to be processed is acquired based on the generative model and the initial answer result.

For calling the target plugin by the generative model to acquire an initial answer result of the target plugin, the present disclosure further provides the following possible embodiments.

1) When the target plugin is a search plugin, based on the generative model, the information to be processed and an induction prompt statement are used as an input, induction processing is performed on the information to be processed according to the induction prompt statement, and a search statement that has the same semantic as the information to be processed is generated. The induction prompt statement is used to indicate an induction requirement for performing the induction processing.

In the embodiments of the present disclosure, when the search ability of the search plugin is specifically implemented, a search term or a search statement need to be input into the search plugin firstly, and then the search plugin performs real-time search to recall a plurality of search results. However, in the embodiment of the present disclosure, the AI tool does not need to return the plurality of search results to the user, which is also not beneficial for the user to quickly acquire the answer. Therefore, the plurality of search results acquired by the search plugin may also be sent to the generative model, then the generative model performs the semantic analysis on the plurality of search results, and one or a preset number of target answer results are generated finally, so as to be returned to the user.

The induction prompt statement is used to indicate the generative model to generate a search statement accorded with the search requirement, and the information to be processed input by the user may has a lot of contents, which is arbitrary and may not be used as the search statement for directly searching. Therefore, in the embodiments of the present disclosure, the information to be processed may be inductive-processed to generate the search statement that has the same semantic as the information to be processed.

Specifically, for performing induction processing on the information to be processed according to the induction prompt statement to generate a search statement that has a same semantic as the information to be processed, the present disclosure further provides the following possible implementations.

In a possible implementation, according to the induction prompt statement, semantic analysis is performed on the information to be processed, the first semantic topic of the information to be processed is determined, and according to the first semantic topic, a search statement accorded with the first semantic topic is extracted from the information to be processed.

In this embodiment, by the induction prompt statement, the generative model may be indicated to summarize the search statement that represents the first semantic topic of the information to be processed. In order to ensure the accuracy and avoid the occurrence of significant deviations, the generative model may be indicated to use a text that has appeared in the information to be processed to extract the search statement from the information to be processed.

In another possible embodiment, semantic analysis is performed on the information to be processed and multi-round dialogue information related to the information to be processed, the second semantic topic corresponding to the information to be processed and the multi-round dialogue information is determined, and according to the second semantic topic, a search statement accorded with the second semantic topic is extracted from the information to be processed and the multi-round dialogue information.

In this embodiment, which is mainly aimed at a scene of multi-round dialogues, at this time, according to the induction prompt statement, the generative model may be indicated to summarize the search statement that may represent the second semantic topic of the multi-round dialogue information, and the generative model may also be indicated to use a text that has appeared in the multi-round dialogue information to extract the search statement.

Further, the induction prompt statement may also include other induction requirements. For example, in response to the multi-round dialogue information including a plurality of paragraphs of semantically unrelated texts, then induction and summarization is performed according to the last round of dialogue. For another example, the form question of the search statement may also be limited, for example, punctuations cannot appear in the search statement, the number of words in the search statement cannot exceed a certain set word number threshold, etc., which is not limited specifically by the embodiments of the present disclosure.

2) The search plugin is called by the generative model, and an initial search result matched with the search statement is acquired based on the search plugin.

Thus, the initial search result acquired can be sent to the generative model, and the generative model further summarizes the initial search result to generate the final target answer result. For example, the generative model may perform semantic analysis on a plurality of initial search results to generate a target answer result, or the generative mode may also generate a plurality of target answer results, which is not limited in the embodiments of the present disclosure.

In a possible situation, when the target plugin is the drawing plugin, the cooperative mode of the search plugin and the generative model is that the target plugin is called by the generative model, and the target answer result of the information to be processed generated by the target plugin is acquired.

Specifically, for calling the target plugin by the generative model to acquire the target answer result of the information to be processed generated by the target plugin, the present disclosure further provides the following possible implements.

1) When the target plugin is a drawing plugin, the information to be processed is used as input based on the generative model, semantic analysis is performed on the information to be processed to extract image key description information corresponding to the information to be processed.

In the embodiments of the present disclosure, for the drawing plugin, in order to improve the drawing accuracy of the drawing plugin, the image key description information of the information to be processed, such as image style information, and image content subject information, etc., may be extracted firstly based on the generative model.

2) The drawing plugin is called, the image key description information is input into the drawing plugin, and an image generation result corresponding to the image key description information is generated based on the drawing plugin.

For example, the drawing plugin is a text to picture model. Based on the text to picture model, the semantic analysis is performed on the image key description information to acquire text feature information of the image key description information. Based on the text feature information, image feature information associated with the text feature information is determined, and the image generation result is acquired according to the image feature information.

Thus, in the embodiments of the present disclosure, for the different plugins such as the drawing plugin or the search plugin, the cooperative interaction of the generative model and the plugin may be implemented based on the cooperative mode that better meets implementation requirement of a capability of the plugin, and finally the target answer result is generated, which may improve the ability implementation performance of the plugin and also improve the accuracy of the target answer result.

The method of information processing in the embodiments of the present disclosure is described below by using a specific application scene. In a possible application scene, the information to be processed is input into the main dialogue flow of the application, and the drawing plugin and the search plugin are included, which is used as an example for description.

As shown in FIG. 2, it is a flow diagram of another method of information processing in an embodiment of the present disclosure. As shown in FIG. 2, for example, when a user opens an application, target functional modules in various vertical scenes are displayed on a homepage of the application. The user does not select a target functional module, but inputs the information to be processed on a chat page of the homepage. Or a comprehensive functional module is also displayed on the homepage, such as an AI assistant, which does not correspond to a specific vertical scene, and the user can select the AI assistant to input the information to be processed.

As shown in FIG. 2, the information to be processed input by the user is received, intention recognition is performed on the information to be processed, and the target plugin matched is called according to a recognized target intention category of the information to be processed. For example, for a drawing intention, the target plugin is a drawing plugin, and for a search intention, the target plugin is a search plugin. Certainly, there may also be other plugins and intentions corresponding to the other plugins. The other plugins are called when it is judged that the user has other intentions.

Thus, a content result output by the target plugin is sent to the generative model, the generative model summarizes the content result to acquire a target answer result, and the target answer result is replied to the user to complete the dialogue.

In addition, when the target plugin is not matched and the generative model can answer the information to be processed, the target answer result is generated directly based on the generative model.

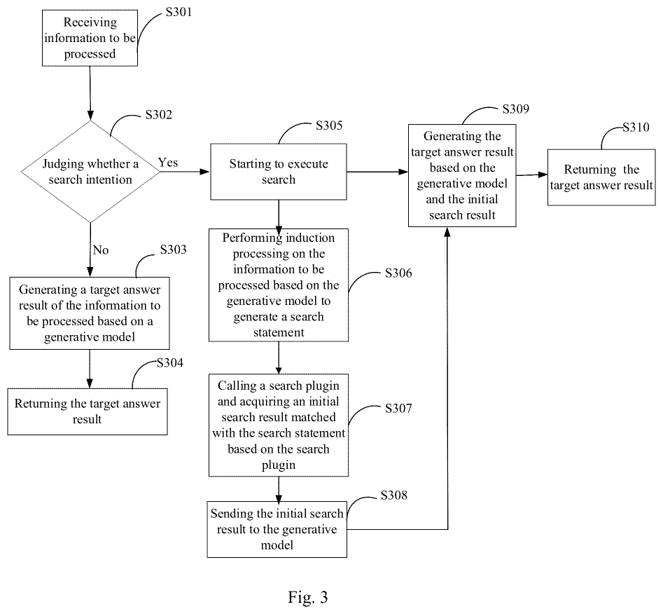

Here, the target plugin as the search plugin is taken as an example, the initial answer result output by the search plugin is the initial search result. As shown in FIG. 3, which is a flow diagram corresponding to a search plugin in a method of information processing in an embodiment of the present disclosure, the method includes S301-S310.

S301: receiving information to be processed.

S302: judging whether the target intention category is a search intention. In response to the search intention, Step S305 is executed, otherwise, Step S303 is executed.

S303: generating a target answer result of the information to be processed based on a generative model.

In this embodiment, which is mainly for the convenience of description, when the target intention category is not the search intention, other target plugins are not matched with the target intention category and the generative model can answer the information to be processed, the semantic analysis can be performed directly on the information to be processed based on the generative model to generate the target answer result of the information to be processed.

S304: returning the target answer result.

S305: starting to execute search.

S306: performing induction processing on the information to be processed based on the generative model to generate a search statement.

S307: calling a search plugin and acquiring an initial search result matched with the search statement based on the search plugin.

S308: sending the initial search result to the generative model.

S309: generating the target answer result based on the generative model and the initial search result.

For example, based on the generative model, the induction and summarization is performed on the initial search results to acquire the final target answer result.

For another example, after starting to execute search, the search plugin may perform the search to acquire a real-time initial search result, and at the same time, the generative model may also answer the information to be processed, the first answer result of the generative model may be acquired, and the generative model summarizes the initial search result and the first answer result to generate the final target answer result.

S310: returning the target answer result.

Thus, in the embodiments of the present disclosure, the target plugin that needs to be called may be determined by the intention recognition, so that the generative model has the ability to call which plugin, thereby answering more questions in different vertical scenes, improving the applicability, and also improving the answering efficiency and accuracy.

In another possible application scene, the information to be processed is input into the target functional module that is selected in the application, which is used as an example for description. In the embodiments of the present disclosure, for a specific target functional module, the associated target plugin may be preset, and different target functional modules may be associated with the same target plugin or may be associated with different target plugins, which is specifically related to the ability requirements and vertical scene division, etc. After the user selects a certain target functional module, the user inputs the information to be processed on the chat page of the target functional module, the target plugin matched with the information to be processed is the preset plugin.

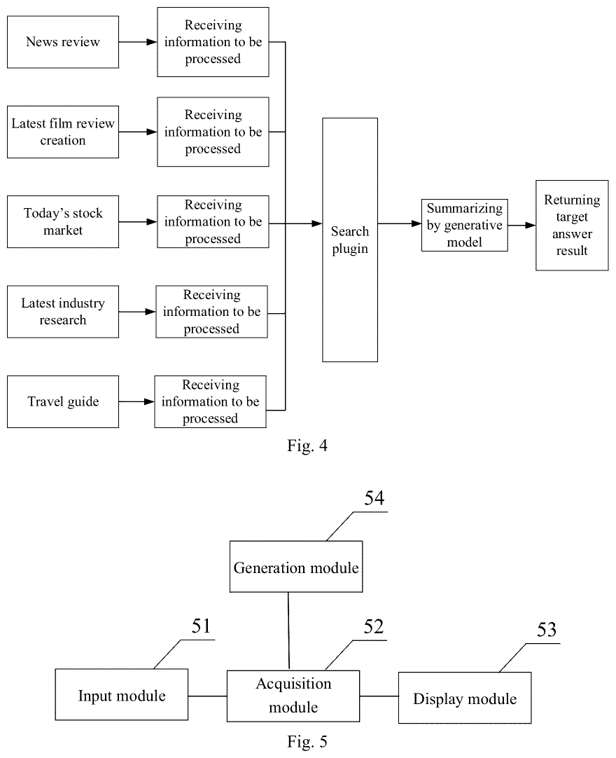

For example, as shown in FIG. 4, it is a flow diagram of another method of information processing in an embodiment of the present disclosure. As shown in FIG. 4, the target functional modules including news review, latest film review creation, today's stock market, latest industry research, travel guide, etc., are taken as an example, and these target functional modules all have timeliness ability requirements. For this type of target functional modules, the target plugin may be directly designated as a search plugin, and when answering the question of the user every time, the search plugin is called to acquire the latest initial search result, and the latest initial search result is sent to the generative model for induction and summarization to acquire the final target answer result.

Thus, in the embodiments of the present disclosure, for specific vertical scenes, there is no need for performing intention recognition, the associated target plugin and the cooperative mode of the target plugin and the generative model may be directly preset, thereby the target answer result may be generated based on the generative model and the target plugin, which has a higher implementation efficiency, meets different vertical scene requirements and improves the performance.

It may be understood by those skilled in the art that in the above methods in the specific embodiments, the writing order of each step does not imply a strict execution order and imposes any limitations on the implementation process, and the specific execution order of each step should be determined based on its functions and possible internal logics.

Based on the same inventive concept, the embodiment of the present disclosure further provides an apparatus of information processing corresponding to the method of information processing. Since the principle of the apparatus solving the problem in the embodiment of the present disclosure is similar to the above method of information processing, the implementation of the apparatus may refer to the implementation of the method, which is not repeatedly described here.

As shown in FIG. 5, which is a schematic diagram of an apparatus of information processing provided by an embodiment of the present disclosure, the apparatus includes an input module 51, an acquisition module 52 and a display module 53.

The input module 51 is configured to receive input information to be processed.

The acquisition module 52 is configured to acquire a target answer result of the information to be processed. The target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed.

The display module 53 is configured to display the target answer result.

In an optional implementation, the apparatus further includes a generation module 54, and the target answer result is determined by the generation module 54 through the following process:
performing intention recognition on the information to be processed to determine a target intention category of the information to be processed, in which the target intention category represents an ability requirement to answer the information to be processed;
determining the target plugin that matches with the target intention category according to the target intention category and association relationships between intention categories and plugins, in which abilities implemented by different plugins are different; and
according to the cooperative mode of the generative model and the target plugin, generating the target answer result based on the generative model and the target plugin.

In an optional implementation, the target answer result is further determined by the generation module 54 through the following process:
when the information to be processed is input for a target functional module that is selected, determining the target plugin associated with the target functional module, in which different target functional modules are used to answer questions in different vertical scenes; and
according to the cooperative mode of the generative model and the target plugin, generating the target answer result based on the generative model and the target plugin.

In an optional implementation, according to the cooperative mode of the generative model and the target plugin, when generating the target answer result based on the generative model and the target plugin, the generation module 54 is configured to:
call the target plugin by the generative model to acquire an initial answer result of the target plugin, and acquire the target answer result of the information to be processed based on the generative model and the initial answer result;
or, call the target plugin by the generative model to acquire the target answer result of the information to be processed generated by the target plugin.

In an optional implementation, when performing intention recognition on the information to be processed to determine a target intention category of the information to be processed, the generation module 54 is configured to:
use the information to be processed and an intention judgment prompt statement as input based on the generative model, perform semantic analysis on words included in the information to be processed according to the intention judgment prompt statement, and determine the target intention category matched with the information to be processed.

The intention judgment prompt statement is used to indicate an ability requirement judgment requirement of the intention categories and represent a word example corresponding to the intention category.

In an optional implementation, when calling the target plugin by the generative model to acquire an initial answer result of the target plugin, the generation module 54 is configured to:
when the target plugin is a search plugin, use the information to be processed and an induction prompt statement as input based on the generative model, perform induction processing on the information to be processed according to the induction prompt statement to generate a search statement that has a same semantic as the information to be processed, in which the induction prompt statement is used to indicate an induction requirement for performing the induction processing; and
call the search plugin by the generative model, and acquiring an initial search result matched with the search statement based on the search plugin.

In an optional implementation, when performing induction processing on the information to be processed according to the induction prompt statement to generate a search statement that has a same semantic as the information to be processed, the generation module 54 is configured to:
perform semantic analysis on the information to be processed according to the induction prompt statement, determine the first semantic topic of the information to be processed, and according to the first semantic topic, extract a search statement accorded with the first semantic topic from the information to be processed;
or, perform the semantic analysis on the information to be processed and multi-round dialogue information related to the information to be processed, determine the second semantic topic corresponding to the information to be processed and the multi-round dialogue information, and according to the second semantic topic, extract a search statement accorded with the second semantic topic from the information to be processed and the multi-round dialogue information.

In an optional implementation, when calling the target plugin by the generative model to acquire the target answer result of the information to be processed generated by the target plugin, the generation module 54 is configured to:
when the target plugin is a drawing plugin, use the information to be processed as input based on the generative model, perform semantic analysis on the information to be processed to extract image key description information corresponding to the information to be processed; and
call the drawing plugin, input the image key description information into the drawing plugin, and generate an image generation result corresponding to the image key description information based on the drawing plugin.

In an optional implementation, the generation module 54 is further configured to, in response to the information to be processed not matching with the target plugin and the generative model answering the information to be processed, perform semantic analysis on the information to be processed based on the generative model to generate the target answer result of the information to be processed.

The description of the processing flow of modules in the apparatus and the interaction flow between the modules can refer to the relevant description in the above-mentioned embodiments of the method, which is not described in detail here.

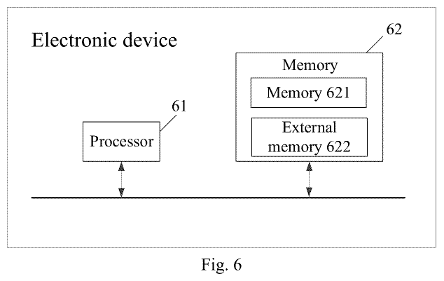

The embodiments of the present disclosure further provide an electronic device, as shown in FIG. 6, which is a structural schematic diagram of an electronic device provided by an embodiment of the present disclosure, the electronic device includes at least one processor 61 and a memory 62.

The memory 62 stores machine-readable instructions that are executed by the processor 61, the processor 61 is used to execute the machine-readable instructions stored in the memory 62, and when the machine-readable instructions are executed by the processor 61, the processor 61 executes the following steps:
receiving input information to be processed;
acquiring a target answer result of the information to be processed, in which the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed; and
displaying the target answer result.

The memory 62 above includes a memory 621 and an external memory 622. The memory 621 here is also called the internal memory, which is used to temporarily store the computing data in the processor 61 and the data exchanged with the external memory 622 such as a hard disk. The processor 61 exchanges data with the external memory 622 through the memory 621.

The specific execution process of the above-mentioned instructions can refer to the steps of the method of information processing described in the embodiments of the present disclosure, which is not repeated here.

The embodiments of the present disclosure further provide a non-transient computer-readable storage medium. Computer programs are stored on the non-transient computer-readable storage medium, and when the computer programs are run by a processor, the steps of the method of information processing describe in the method embodiments are implemented. The storage medium can be a volatile or non-volatile computer-readable storage medium.

The embodiments of the present disclosure further provide a computer program product, the computer program product carries program codes, and the program codes includes instructions that can be used to execute the steps of the method of information processing described in the above-mentioned method embodiments, which can be referred to the above-mentioned method embodiments specifically and not be repeated herein.

The computer program product may be implemented in hardware, software, or a combination thereof. In an optional embodiment, the computer program product is specifically embodied as a computer storage medium, and in another optional embodiment, the computer program product is specifically embodied in a software product, such as a software development kit (SDK), etc.

Those skilled in the art can clearly understand that, for the convenience and conciseness of the description, the specific working process of the apparatus described above may refer to the corresponding process in the aforesaid method embodiments, which will not be repeated herein. In some embodiments provided by the present disclosure, it should be understood that the apparatus and method disclosed can be implemented by other means. The apparatus embodiments described above are only schematic, for example, the division of the units is only a logical function division, and there may be another division method when the apparatus is actually implemented, and for example, a plurality of units or components can be combined, or some features can be ignored or not executed. On the other hand, the coupling or direct coupling or communication connection between each other shown or discussed may be indirect coupling or communication connection through some communication interfaces, apparatuses or units, which may be in electrical, mechanical or other form.

The unit described as a separate component may be or may not be physically separated, and the component displayed as a unit may be or may not be a physical unit, i.e., may be located in a place, or may also be distributed on a plurality of network units. Some or all of the units can be selected according to actual needs to implement the purpose of the present embodiment solution.

In addition, the functional units in the embodiments of the present disclosure may be integrated in a processing unit, or each unit may exist separately physically, or two or more than two units may be integrated in a unit.

If the described function is implemented in the form of a software functional unit and marketed or used as an independent product, the function may be stored in a non-volatile computer-readable storage medium that can be executed by a processor. Based on this understanding, the technical solution of the present disclosure in essence or the part that contributes to the prior art or the part of the technical solution may be embodied in the form of a software product, and the computer software product is stored in a storage medium that includes several instructions for enabling a computer device (which may be a personal computer, a server, or a network device, etc.) to execute all or part of the steps of the method described in the embodiments of the present disclosure. The aforementioned storage medium includes various media that can store program codes, such as a USB flash drive, a mobile hard disk, a Read-Only Memory (ROM), a Random Access Memory (RAM), a disk, an optical disc, etc.

Finally, it should be noted that the above-mentioned embodiments are only specific embodiments of the present disclosure, which are used to illustrate the technical solutions of the present disclosure and not to limit them, and the scope of protection of the present disclosure is not limited to this. Although the present disclosure is described in detail with reference to the aforesaid embodiments, a person skilled in the art should understand that any person skilled in the art who is familiar with the art can still modify the technical solutions described in the aforesaid embodiments or can easily think of changes within the scope of the technology disclosed in the disclosure, or the equivalent substitution of some of the technical features. These modifications, changes or substitutions do not depart the essence of the corresponding technical solutions from the spirit and scope of the technical solutions of the embodiments of the present disclosure, which shall be covered in the scope of protection of the present disclosure. Therefore, the scope of protection of the present disclosure shall be stated in accordance with the scope of protection of the claims.

1. A method of information processing, comprising:
receiving input information to be processed;
acquiring a target answer result of the information to be processed, wherein the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed; and
displaying the target answer result.

2. The method according to claim 1, wherein the target answer result is determined by:
performing intention recognition on the information to be processed to determine a target intention category of the information to be processed, wherein the target intention category represents an ability requirement to answer the information to be processed;
determining the target plugin that matches with the target intention category according to the target intention category and association relationships between intention categories and plugins, wherein abilities implemented by different plugins are different; and
according to the cooperative mode of the generative model and the target plugin, generating the target answer result based on the generative model and the target plugin.

3. The method according to claim 1, wherein the target answer result is determined by:
when the information to be processed is input for a target functional module that is selected, determining the target plugin associated with the target functional module, wherein different target functional modules are used to answer questions in different vertical scenes; and
according to the cooperative mode of the generative model and the target plugin, generating the target answer result based on the generative model and the target plugin.

4. The method according to claim 2, wherein, the according to the cooperative mode of the generative model and the target plugin, generating the target answer result based on the generative model and the target plugin, comprises:
calling the target plugin by the generative model to acquire an initial answer result of the target plugin, and acquiring the target answer result of the information to be processed based on the generative model and the initial answer result;
or,
calling the target plugin by the generative model to acquire the target answer result of the information to be processed generated by the target plugin.

5. The method according to claim 2, wherein the performing intention recognition on the information to be processed to determine a target intention category of the information to be processed, comprises:
using the information to be processed and an intention judgment prompt statement as input based on the generative model, performing semantic analysis on words comprised in the information to be processed according to the intention judgment prompt statement, and determining the target intention category matched with the information to be processed,
wherein the intention judgment prompt statement is used to indicate an ability requirement judgment requirement of the intention categories and represent a word example corresponding to the intention category.

6. The method according to claim 4, wherein the calling the target plugin by the generative model to acquire an initial answer result of the target plugin, comprises:
when the target plugin is a search plugin, using the information to be processed and an induction prompt statement as input based on the generative model, performing induction processing on the information to be processed according to the induction prompt statement to generate a search statement that has a same semantic as the information to be processed, wherein the induction prompt statement is used to indicate an induction requirement for performing the induction processing; and
calling the search plugin by the generative model, and acquiring an initial search result matched with the search statement based on the search plugin.

7. The method according to claim 6, wherein the performing induction processing on the information to be processed according to the induction prompt statement to generate a search statement that has a same semantic as the information to be processed, comprises:
performing semantic analysis on the information to be processed according to the induction prompt statement, determining a first semantic topic of the information to be processed, and according to the first semantic topic, extracting a search statement accorded with the first semantic topic from the information to be processed;
or,
performing the semantic analysis on the information to be processed and multi-round dialogue information related to the information to be processed, determining a second semantic topic corresponding to the information to be processed and the multi-round dialogue information, and according to the second semantic topic, extracting a search statement accorded with the second semantic topic from the information to be processed and the multi-round dialogue information.

8. The method according to claim 4, wherein the calling the target plugin by the generative model to acquire the target answer result of the information to be processed generated by the target plugin, comprises:
when the target plugin is a drawing plugin, using the information to be processed as input based on the generative model, and performing semantic analysis on the information to be processed to extract image key description information corresponding to the information to be processed; and
calling the drawing plugin, inputting the image key description information into the drawing plugin, and generating an image generation result corresponding to the image key description information based on the drawing plugin.

9. The method according to claim 1, further comprising:
in response to the information to be processed not matching with the target plugin and the generative model answering the information to be processed, performing semantic analysis on the information to be processed based on the generative model to generate the target answer result of the information to be processed.

10. The method according to claim 3, wherein, the according to the cooperative mode of the generative model and the target plugin, generating the target answer result based on the generative model and the target plugin, comprises:
calling the target plugin by the generative model to acquire an initial answer result of the target plugin, and acquiring the target answer result of the information to be processed based on the generative model and the initial answer result;
or,
calling the target plugin by the generative model to acquire the target answer result of the information to be processed generated by the target plugin.

11. An electronic device, comprising:
at least one processor and at least one memory, wherein the memory stores machine-readable instructions that are executed by the at least one processor, the at least one processor is used to execute the machine-readable instructions stored in the memory, and when the machine-readable instructions are executed by the at least one processor, the at least one processor executes steps of a method of information processing, and the method of information processing comprises:
receiving input information to be processed;
acquiring a target answer result of the information to be processed, wherein the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed; and
displaying the target answer result.

12. The electronic device according to claim 11, wherein the target answer result is determined by:
performing intention recognition on the information to be processed to determine a target intention category of the information to be processed, wherein the target intention category represents an ability requirement to answer the information to be processed;
determining the target plugin that matches with the target intention category according to the target intention category and association relationships between intention categories and plugins, wherein abilities implemented by different plugins are different; and
according to the cooperative mode of the generative model and the target plugin, generating the target answer result based on the generative model and the target plugin.

13. The electronic device according to claim 11, wherein the target answer result is determined by:
when the information to be processed is input for a target functional module that is selected, determining the target plugin associated with the target functional module, wherein different target functional modules are used to answer questions in different vertical scenes; and
according to the cooperative mode of the generative model and the target plugin, generating the target answer result based on the generative model and the target plugin.

14. The electronic device according to claim 12, wherein, the according to the cooperative mode of the generative model and the target plugin, generating the target answer result based on the generative model and the target plugin, comprises:
calling the target plugin by the generative model to acquire an initial answer result of the target plugin, and acquiring the target answer result of the information to be processed based on the generative model and the initial answer result;
or, calling the target plugin by the generative model to acquire the target answer result of the information to be processed generated by the target plugin.

15. The electronic device according to claim 12, wherein the performing intention recognition on the information to be processed to determine a target intention category of the information to be processed, comprises:
using the information to be processed and an intention judgment prompt statement as input based on the generative model, performing semantic analysis on words comprised in the information to be processed according to the intention judgment prompt statement, and determining the target intention category matched with the information to be processed;
wherein the intention judgment prompt statement is used to indicate an ability requirement judgment requirement of the intention categories and represent a word example corresponding to the intention category.

16. A non-transient computer-readable storage medium, wherein computer programs are stored in the non-transient computer-readable storage medium, and when the computer programs are executed by a processor, steps of a method of information processing are implemented, and the method of information processing comprises:
receiving input information to be processed;
acquiring a target answer result of the information to be processed, wherein the target answer result is generated based on a generative model and a target plugin, a cooperative mode when the generative model and the target plugin generate the target answer result is related to an implementation requirement of a capability of the target plugin, and the target plugin is a plugin that matches with the information to be processed and is used to answer the information to be processed; and
displaying the target answer result.

17. The non-transient computer-readable storage medium according to claim 16, wherein the target answer result is determined by:
performing intention recognition on the information to be processed to determine a target intention category of the information to be processed, wherein the target intention category represents an ability requirement to answer the information to be processed;
determining the target plugin that matches with the target intention category according to the target intention category and association relationships between intention categories and plugins, wherein abilities implemented by different plugins are different; and
according to the cooperative mode of the generative model and the target plugin, generating the target answer result based on the generative model and the target plugin.

18. The non-transient computer-readable storage medium according to claim 16, wherein the target answer result is determined by:
when the information to be processed is input for a target functional module that is selected, determining the target plugin associated with the target functional module, wherein different target functional modules are used to answer questions in different vertical scenes; and
according to the cooperative mode of the generative model and the target plugin, generating the target answer result based on the generative model and the target plugin.

19. The non-transient computer-readable storage medium according to claim 17, wherein, the according to the cooperative mode of the generative model and the target plugin, generating the target answer result based on the generative model and the target plugin, comprises:
calling the target plugin by the generative model to acquire an initial answer result of the target plugin, and acquiring the target answer result of the information to be processed based on the generative model and the initial answer result;
or, calling the target plugin by the generative model to acquire the target answer result of the information to be processed generated by the target plugin.

20. The non-transient computer-readable storage medium according to claim 17, wherein the performing intention recognition on the information to be processed to determine a target intention category of the information to be processed, comprises:
using the information to be processed and an intention judgment prompt statement as input based on the generative model, performing semantic analysis on words comprised in the information to be processed according to the intention judgment prompt statement, and determining the target intention category matched with the information to be processed;
wherein the intention judgment prompt statement is used to indicate an ability requirement judgment requirement of the intention categories and represent a word example corresponding to the intention category.
